(19) United States
(12) Patent Application Publication
(10) Pub. No.: US 2023/0417949 A1
(43) Pub. Date: Dec. 28, 2023

(54) METHOD FOR DETERMINING UNCERTAINTIES ASSOCIATED WITH A MODEL OF A SEDIMENTARY BASIN

(71) Applicant: IFP Energies nouvelles, RUEIL-MALMAISON (FR)

(72) Inventors: Veronique GERVAIS-COUPLET, RUEIL-MALMAISON CEDEX (FR); Sarah BOUQUET, RUEIL-MALMAISON CEDEX (FR)

(21) Appl. No.: 18/038,253

(22) PCT Filed: Nov. 16, 2021
(86) PCT No.: PCT/EP2021/081888

§ 371 Date: May 23, 2023

(30) Foreign Application Priority Data
Nov. 27, 2020 (FR) 2012260

(51) Int. Cl. G01V 99/00; E21B 49/00

(52) U.S. Cl. CPC G01V 99/005; E21B 49/00; E21B 2200/20

(57) ABSTRACT

The invention is a method for determining uncertainties of a property of a sedimentary basin, comprising determining realizations of a spatial distribution of the property for combinations of uncertain parameters of a stratigraphic simulation or of a basin simulation, applying a principal component analysis to the realizations, and determining an approximate analytical model of the spatial distribution of the property by constructing an approximate analytical model for a selection of components whose sum of eigenvalues is greater than a predefined threshold. The approximate analytical model is iteratively improved by determining, at each iteration, at least one additional combination of uncertain parameters by adaptive sequential planning applied to the approximate analytical models of the selected components taken in descending order. The uncertainties of the properties are thereafter determined from the approximate analytical model.

### CROSS REFERENCE TO RELATED APPLICATIONS

Reference is made to PCT/EP2021/081888 filed Nov. 16, 2021, and French Application No. 2012260 filed Nov. 27, 2020, which are incorporated herein by reference in their entirety.

### BACKGROUND OF THE INVENTION

### Field of the Invention

The present invention relates to the exploration and exploitation of petroleum reservoirs or geological gas storage sites. The present invention also relates to the field of new energies such as geothermal energy or underground energy storage. In general terms, the present invention can be used in any field requiring characterization of the geometry and the nature of the sedimentary rocks that make up the subsoil, and optionally of the nature of the hydrocarbons present in the subsoil.

### Description of the Prior Art

Petroleum exploration is the search for hydrocarbon reservoirs within a sedimentary basin. The general procedure for assessing the petroleum potential of a sedimentary basin comprises shuttles between a prediction of the petroleum potential of the sedimentary basin, from measured data relative to the basin under study (outcrop analysis, seismic surveys, drilling data for example), and exploratory drilling operations in the zones having the best potential, in order to confirm or invalidate the previously predicted potential, and to acquire new data intended to specify the petroleum potential predictions for the basin under study.

Petroleum reservoir exploitation consists from data collected during the petroleum exploration phase, selects the reservoir zones with the best petroleum potential, in defining exploitation schemes for these zones (using reservoir simulation for example in order to define the number and positions of the exploitation wells allowing maximum hydrocarbon recovery), in drilling exploitation wells and, in general terms, in developing the production infrastructures necessary for reservoir development.

Petroleum potential assessment of a sedimentary basin is most often performed using software programs executed by computers, enabling synthesis of the available data and simulation of the geological history of the basin under study. These software programs enable one-, two- or three-dimensional simulation of the sedimentary, tectonic, thermal, hydrodynamic, organic and inorganic chemical processes involved in the formation of a petroleum basin.

In particular, the purpose of stratigraphic simulation is to simulate the evolution of a sedimentary basin over geologic time in order notably to quantify the geometry of sedimentary layers, the type of sediments that have settled, the water depth at the time of deposition, etc. Basin simulation allows stimulation over geologic time the formation of hydrocarbons notably from the organic matter initially buried with the sediments, and the transport of these hydrocarbons from the rocks where they were formed to those where they are trapped. At the end of a stratigraphic simulation or of a basin simulation, a basin model is obtained, in the form of a numerical representation such as with a grid or a mesh, each grid cell comprising at least one value of a property relative to the basin (geometry of sedimentary layers, sediment composition, pressure, temperature, hydrocarbon proportion and nature, etc.). The values of these properties are subsequently analyzed, notably to assess the petroleum potential of the basin under study.

In general, basin models must at least reproduce the measurements performed in the basin, such as bottomhole measurements or seismic acquisition data. The result of a simulation however depends directly on the simulation input parameters such as initial bathymetry, sediment transport coefficients or sediment supply for stratigraphic simulation, or organic matter type, petrophysical properties of rocks, physico-chemical properties of fluids, temperatures and pressures for basin simulation. These simulation parameters are generally estimated from various measurements performed in situ, but the available data is generally not informative enough for uniquely characterizing the input parameters of these simulations. Thus, different models may reproduce measurements performed in a basin while corresponding to a different state of the basin at the current time. It is therefore important to quantify uncertainties associated with the basin property values resulting from simulation in order to include them in the process of assessing the petroleum potential of the basin, and notably in the exploration risk assessment.

One way of carrying out such studies is choosing a probabilistic approach and considering the input parameters of the numerical simulations involved in basin modeling as random variables having a given probability law (uniform in a given range or Gaussian for example). These laws are selected by the user according to their expertise and basin knowledge, and they may be obtained for example from calibration of the model on the available data (measurements). One can then seek to estimate the corresponding distribution of the properties of interest. Sampling methods of Monte Carlo type can be used. A large set of models is generated according to the laws of the parameters (set of values for the input parameters), and the evolution of these models over time is simulated. This provides a sample of values for the simulated properties that can be subsequently analyzed and used to estimate the probability distribution of a given event and/or situation, knowing the uncertainty taken for the input parameters. These events are characterized by a target value range for a given property, or by the joint presence of several properties in target ranges. This type of analysis can be carried out on scalar properties representing, for example, regional characteristics of the basin, such as the average of a property, or on the spatial distribution of properties in a set of cells (3D block, map, 2D section, etc.). It is for example possible to estimate a probability map of the presence of a reservoir defined by the probability in each column of cells of the basin that the deposited sediment thickness and the sand concentration are above a certain threshold. This map can be subsequently used to estimate an exploration risk. It should also be noted that approaches based on sampling of input parameters and associated basin properties provide an estimation of the impact of these parameters on the simulated properties considered (sensitivity analysis).

However, such analyses require a large number of simulations (several thousands for example) to obtain representative samples, which is hardly feasible within the context of an operational study due to the long simulation times and the short deadlines involved. The following documents are mentioned in the description:
1. Douarche, F., Da Veiga, S., Feraille, M., Enchery, G., Touzani, S. and Barsalou, R. (2014) Sensitivity Analysis and Optimization of Surfactant-Polymer Flooding under Uncertainties: Oil & Gas Science and Technology—Rev. IFP Energies nouvelles, v. 69, no. 4, p. 603-617.
2. Gervais, V., Ducros, M., Granjeon, D. (2018) Probability Maps of Reservoir Presence and Sensitivity Analysis in Stratigraphic Forward Modeling. AAPG Bulletin, 102(4)
3. Ducros, M., Nader F. (2020) Map-Based Uncertainty Analysis for Exploration Using Basin Modeling and Machine Learning Techniques Applied to the Levant Basin Petroleum Systems, Eastern Mediterranean. Marine and Petroleum Geology, 120.
4. Jin, R., Chen, W., Sudjianto, A. (2002), On Sequential Sampling for Global Metamodeling in Engineering Design. Proceedings of DETC'02, ASME 2002 Design Engineering Technical Conference and Computers and Information in Engineering Conference, Montreal, Canada, Sep. 29-Oct. 2, 2002.
5. Sacks, J., Welch, W. J., Mitchell, T. J., Wynn, H. P. (1989) Design and Analysis of Computer Experiments. Stat. Sci. 4(4), 409-423.
6. Le Gratiet, L., Cannamela, C. (2015). Cokriging-Based Sequential Design Strategies Using Fast Cross-Validation Techniques for Multi-Fidelity Computer Codes. Technometrics, 57(3), pp. 418-427.
7. Picheny, V., Ginsbourger, D., Roustant, O., Haftka, R., Kim N-H (2010). Adaptive Designs of Experiments for Accurate Approximation of a Target Region. Journal of Mechanical Design, 132(7), pp. 071008-1-071008-9
8. Busby, D. (2009). Hierarchical Adaptive Experimental Design for Gaussian Process Emulators. Reliability Engineering and System Safety 94, pp 1183-1193.
9. Granjeon, D. and P. Joseph (1999) Concepts and Applications of a 3-D Multiple Lithology, Diffusive Model in Stratigraphic Modeling, in J. W. Harbaugh, W. L. Watney, E. C. Rankey, R. Slingerland, and R. H. Goldstein, eds, Numerical Experiments in Stratigraphy: Recent Advances in Stratigraphic and Sedimentologic Computer Simulations, SEPM Special Publication 62, p. 197-210
10. Scheichl R., Masson R., Wendebourg J. (2003), Decoupling and Block Preconditioning for Sedimentary Basin Simulations, Computational Geosciences 7(4), pp. 295-318.
11. Steckler, M. S. and Watts, A. B. (1978) Subsidence of the Atlantic Type Continental Margin off New York. Earth and Planetary Science Letters, 41, 1-13
12. Sobol', I. M. (1990) On sensitivity estimation for nonlinear mathematical models: Mathematical Modeling & Computational Experiment, vol. 1, no. 4, p. 407-414.

To overcome this problem, it is possible to rely on metamodels that approach the relation between the model input parameters and the scalar outputs of interest. One also considers response surfaces or approximate analytical models. Each of these metamodels is constructed from a set of values of the sought property—the training set—simulated for a sample of the input parameters—the design of experiments. It provides an estimate of the scalar output considered for any value of the input parameters. If these estimates are accurate, i.e. close to the corresponding simulated values, the metamodel can be used to replace the simulator during risk or sensitivity analyses. In this case, the only simulations to be performed are those enabling construction of the training set.

Various techniques exist for constructing such metamodels, such as polynomial regression, Gaussian processes or neural networks. In some cases, the outputs of interest are referred to as functional because they depend for example on time or on the position in the basin. It may be, for example, the distribution of the sediment deposit thickness in each column of the grid, or the temperature distribution in the basin. For this type of outputs, the metamodel approach can be applied to each time or location of interest. One way of reducing the number of variables to be predicted, and therefore the computation times, introduces dimension reduction techniques in the process (see document [1] for example). More precisely, a reduced basis decomposition (of PCA type for example) is applied to all the simulated values for the models of the design of experiments in the zone of interest (maps, blocks, sections). Metamodeling is then applied not to the simulated outputs directly, but to the weights associated with each vector of the reduced basis. The simulation outputs are subsequently estimated by linear combination of the reduced basis with the values predicted for the associated weights.

Using metamodels for risk analyses and sensitivity analyses is a widely used technique in many applications. As regards basin-scale subsoil modeling, the work presented in documents [2, 3] can notably be mentioned. The limited number of simulations to be carried out makes this type of analyses accessible within the context of operational studies.

However, the main difficulty lies in the selection of the training set. Ideally, it is desirable to generate the smallest possible design of experiments, leading to satisfactory estimates in terms of accuracy. It is however difficult to know beforehand the number of simulations required to obtain such estimators, or the suitable value for the simulation parameters in the design of experiments. This notably depends on the number of uncertain parameters, and on the complexity of the relation between these parameters and the response. In order to optimize the training set construction process, various methods have been proposed in the engineering field in general, but not specifically in the field of basin simulation or stratigraphic simulation, for sequentially completing a design of experiments with new simulations according to a given criterion. Some use only the position of the points already simulated in the parameter space to propose new ones. They are referred to as non-adaptive methods. The maximin criterion (see document [4]), which aims to best cover the parameter space according to geometric criteria, can be mentioned by way of example. Other approaches, referred to as adaptive methods, use both the already simulated sample and the information provided by the current metamodel to select the new points. The criterion used then depends on the objective of the study. For risk analyses and sensitivity analyses, it is sought to identify predictive estimators in the entire uncertain parameter space. At each iteration, one or more new complementary points are proposed, which may subsequently be simulated simultaneously, on a computer cluster for example.

However, these methods, from the engineering field in general, only apply to a single metamodel approaching a single scalar output whose quality is to be improved thereby, by use of the new selected point. They can therefore be directly applied to estimate a physical quantity, for example a property of interest in a given cell. If this property is to be predicted in a set of cells without going through a reduced basis decomposition (functional output), adaptive methods can be applied in each cell. However, if many cells are considered, this can lead to add to the design of experiments as many simulations as there are cells, which might not be optimal in terms of computation time and of computer memory used.

The present invention is directed to overcoming these drawbacks. The present invention concerns an automatic and effective method for quantifying uncertainties for spatial outputs in basin modeling in the broad sense (stratigraphic simulation and basin simulation). The present invention is based on coupling adaptive sequential planning methods to processing of functional outputs by reduced basis decomposition. It allows both to limit the number of metamodels to be computed, and therefore computation time and computer memory, and to complete at each iteration the design of experiments with new points intended to globally improve the estimation of the property of interest in all the cells being considered. Besides, the training set is constructed in real time until relevant stopping criteria, notably representative of the quality of estimation of the spatial properties of interest, are reached.

### SUMMARY OF THE INVENTION

The present invention relates to a method for determining uncertainties relative to at least one physical property of a sedimentary basin, through a numerical simulation carried out from simulation parameters, the numerical simulation being a computer-implemented stratigraphic simulation or basin simulation.

The method according to the invention is characterized in that at least the following steps are carried out:
A) carrying out measurements of physical quantities relative to the basin using sensors, and determining at least values of the simulation parameters;
B) selecting uncertain simulation parameters, and defining combinations of the possible values of the uncertain simulation parameters;
C) determining grid representations of the basin by using the numerical simulation, each of the grid representations being obtained for one of the combinations of the possible values of the uncertain parameters, each of the cells of one of the grid representations comprising at least one value allowing the property to be determined;
and for at least one of the physical properties of the sedimentary basin, at least the following steps are carried out;
D) for each of the grid representations, determining a realization of a spatial distribution of the property, applying a principal component analysis to the realizations of the spatial distribution of the property, selecting the components whose sum of associated eigenvalues is greater than a predefined threshold, and determining an approximate analytical model of the spatial distribution of the property by constructing an approximate analytical model for each of the selected components;
E) as long as a stopping criterion is not satisfied, improving accuracy of the approximate analytical model of the spatial distribution of the property iteratively by determining, at each iteration, at least one additional combination of the possible values of the uncertain parameters by use of an adaptive sequential planning method, the adaptive sequential planning method being applied to the approximate analytical models of the selected components, by considering the components in descending order of their eigenvalues, until a value of an accuracy indicator relative to at least the component considered at the current iteration is reached, and by repeating steps C) and D); and wherein from the improved approximate analytical model of the spatial distribution of the at least one improved physical property, the uncertainties relative to at least the spatial distribution of the property of the sedimentary basin model are determined.

According to an implementation of the invention, the at least one stopping criterion can depend on at least one accuracy indicator on the approximate analytical models of the components.

According to an implementation of the invention, an approximate analytical model can be determined by use of a Gaussian process regression.

According to an implementation of the invention, the adaptive sequential planning method can be selected from among the list as follows: a method of estimating the maximum kriging variance, a cross validation error-weighted method of estimating the maximum kriging variance, a kriging variance integration method, or hierarchical designs of experiments.

According to an implementation of the invention, in case of a plurality of physical properties of the basin, steps C) to E) can be applied for each of the physical properties of the basin.

The invention further relates to a computer program product at least one of downloadable from a communication network, recorded on a computer-readable medium and a processor executable, non-transient program code instructions for implementing the method as described above, when the program is executed on a computer.

The invention also relates to a method for exploiting hydrocarbons present in a sedimentary basin, the method comprising at least implementing the method for determining uncertainties relative to at least one physical property of a sedimentary basin as described above, and wherein, from at least one of the improved approximate analytical model and the uncertainties relative to at least the physical property, a development scheme comprising at least one site for at least one of an injection well and at least one production well is determined for the basin, and the hydrocarbons of the basin are exploited at least by drilling the wells on the site and by providing them with exploitation infrastructures.

### BRIEF DESCRIPTION OF THE DRAWINGS

Other features and advantages of the method according to the invention will be clear from reading the description hereafter of non-limitative example embodiments, with reference to the accompanying figures wherein:

FIG. 1 illustrates the evolution, as a function of the number of simulations, of a first accuracy indicator for four components of an approximate analytical model of a spatial distribution of interest;

FIG. 2 illustrates the evolution, as a function of the number of simulations, of a second accuracy indicator of an approximate analytical model of a spatial distribution of interest; and

FIG. 3 illustrates the distribution of the values of the first accuracy indicator of an approximate analytical model of a spatial distribution of interest in each cell of the spatial distribution of interest.

### DETAILED DESCRIPTION OF THE PREFERRED EMBODIMENTS

According to a first aspect, the invention relates to a method for determining uncertainties relative to at least one physical property relative to a sedimentary basin, by use of a numerical simulation performed from simulation parameters. The numerical simulation according to the invention can be a stratigraphic simulation or a basin simulation. The numerical simulations according to the invention are more fully described in section 3) hereafter. The method according to the first aspect of the invention comprises at least steps 1 to 6 described below.

According to a second aspect, the invention relates to a method for exploiting hydrocarbons present in a sedimentary basin, by use of the uncertainties relative to at least the physical property of the basin. The method according to the second aspect of the invention further comprises at least step 7 described hereafter.

The steps of the methods according to the first and the second aspects are described hereafter in the non-limitative case of a single physical property of interest. In the case of a set of physical properties of interest, by way of non-limitative example, steps 4 and 5 can be sequentially repeated for each physical property of interest.

A physical property of the basin is understood to be, for example, the thickness of a stratigraphic unit, the sand concentration, the clay concentration in a stratigraphic unit, temperature, pressure, porosity, density, saturation or TOC (total organic carbon).

1) Measurement of Physical Quantities Relative to the Basin

This step performs measurements of physical quantities relative to the sedimentary basin under study using sensors, and in deducing therefrom at least values of the parameters of the numerical simulation being considered.

According to an implementation of the invention, physical quantity measurements comprise at least logging measurements and seismic measurements. Advantageously, physical quantity measurements can also comprise measurements performed on at least one of outcrops, petrophysical and geochemical analyses of core samples taken in situ.

Logging measurements are understood to be measurements performed in at least one well drilled in a basin, using a logging device or sonde moving along the well to measure a physical quantity relative to the geological formation close to the well. Logging measurements allow estimation for example the water and hydrocarbon content at each measuring step in the well, the dominant lithology (or lithologic facies), and notably at least one of the sand and clay content of the traversed rocks, as well as dip and layer thickness. According to an implementation of the invention, the measured physical quantities can comprise electrical resistivity, natural gamma radioactivity and spontaneous polarization. Logging measurement is a local measurement along the well, of limited lateral extension.

Seismic measurements are understood to be measurements performed using a seismic data acquisition device, conventionally comprising at least one seismic source (a water gun for marine seismic or a vibrator truck for land seismic measurement for example) for generating seismic waves in the basin, and seismic wave receivers (such as accelerometers, hydrophones) positioned to record at least seismic waves reflected on impedance contrasts of the basin (such as erosional surfaces, stratigraphic unit boundaries). Conventionally, the seismic acquisition device is mobile to cover a large zone (2D or 3D) on the surface of the basin.

By way of non-limitative example, the sensors may further be fluid samplers and analyzers, core samplers and analyzers, or such devices intended for any sample taken.

These measurements notably allow assessing the current geometry of the stratigraphic units of the basin, to qualify the various inorganic sediment deposits (mineralogical composition or at least deposit type, thickness, age, depositional conditions, etc.), to assess petrophysical properties such as facies (lithology), porosity, permeability, fluid saturation or organic matter content at measuring points of the basin. Geological events undergone by the basin over geologic times (erosion, subsidence, eustasy, etc.) can further be deduced therefrom. The information deduced from measurements is however uncertain since it results from possibly preprocessed measurements (notably seismic measurements), or from a measurement interpretation (assessment of the stratigraphic unit geometry based on seismic measurements for example).

According to an implementation of the invention, the measurements thus performed can further allow defining the input parameters of a stratigraphic simulation, such as the initial bathymetry, the sediment supply (inorganic sediments, such as the production of the different carbonates, and possibly organic sediments), their transport for each time step. According to an implementation of the invention, the initial bathymetry can be assessed by a (fluvial, coastal, deep sea, etc.) depositional environment interpretation of at least one of well data and seismic data. According to an implementation of the invention, the transport coefficients can be defined from modern sedimentary environments i.e. observed at the current time by comparing for example the flow of sediments transported by rivers with the discharge of these rivers. According to an implementation of the invention, the sediment supply can be assessed from the volume of sediments deposited in the basin.

These measurements can also allow defining the input parameters of a basin simulation, in particular petrophysical properties associated with the basin under study, such as facies (lithology), porosity, permeability, or the organic matter content at measuring points of the basin. Information on the properties of fluids present in the basin, such as values of saturation in the various fluids present in the basin, can further be deduced therefrom. Temperatures can also be measured at different points of the basin (notably borehole temperatures).

In case of basin simulation, these measurements can further be used to construct a grid pattern representative of the basin in the current state. More precisely, construction of a grid representation of a basin discretizes the basin architecture in three dimensions and assigns properties to each of the cells of this grid representation. The physical quantities measured at different points of the basin as described above are therefore notably at least one of exploited, extrapolated and interpolated, in the various cells of the grid representation, according to more or less restrictive hypotheses. In most cases, spatial discretization of a sedimentary basin is organized in cell layers representing each the different geological layers of the basin under study.

At the end of this step, at least input parameter values of the numerical simulation being considered are thus obtained from the physical quantities measured in the basin.

2) Definition of Value Combinations for Uncertain Simulation Parameters

This step selects uncertain simulation parameters and defines possible value combinations for the uncertain simulation parameters.

An uncertain simulation parameter is understood to be a simulation parameter whose value for the basin being considered is not known with certainty. In other words, this involves simulation parameters for which uncertainties are above a predefined threshold, for example above 10%. Advantageously, among all the uncertain parameters, those whose variation in their plausible range of values leads to a significant simulation result variation, notably values of the physical property of interest, are selected. In other words, among all the uncertain parameters, those for which it seems important to study the impact on the values of the physical property of interest are selected.

In general, a person skilled in the art is fully aware of how to identify uncertain simulation parameters from among all the parameters of a simulation.

According to an implementation of the invention, uncertainties on the simulation parameters can be determined from uncertainties on the physical quantity measurements relative to the basin described in the previous step.

According to another implementation of the invention, uncertainties on the simulation parameters can be estimated from bibliographic information relative to the basin under study or analogs.

According to an implementation of the invention, in order to identify uncertain parameters having a strong impact on simulation, some numerical simulations (3 to 5 per uncertain parameter for example) can be carried out beforehand for different predefined simulation parameter values, and a first sensitivity analysis is performed depending on the result of these simulations. For example, if only one parameter is varied and an equivalent simulation result is obtained whatever the value of this parameter, it may be assumed that it is not necessary to consider this parameter in the analysis. On the other hand, if different values of the parameter give a very different simulation result, it may be important to quantify the uncertainties on the property of interest associated with this parameter.

According to an implementation of the invention, combinations of the possible values of the uncertain simulation parameters can be defined from probability distribution laws associated with the uncertain parameters. The probability law can for example be uniform between a minimum value and a maximum value.

Advantageously, possible value combinations can be defined for the uncertain simulation parameters using a sampling method. These sampling techniques are also known as design of experiments. According to an implementation of the invention, factorial designs, composite designs, maximin distance designs, etc., can be used by way of non-limitative example. Advantageously, the Latin hypercube sampling method as described in document [8] can be used.

In the following, it is assumed that a design of experiments denoted by D=(θⱼ)_{j=1 . . . n}, comprising a number n of possible value combinations for the uncertain parameters, has been generated.

3) Determination of Grid Representations of the Basin

This step determines grids representative of the basin using the numerical simulation being considered, each grid representation being obtained for one of the combinations of the possible value combinations of the uncertain parameters. According to an implementation of the invention, the grid representation discussed here is a grid representation at the current time, but the method of the invention can be applied to a grid representation determined for any geologic time.

According to an implementation of the invention, the numerical simulation is performed by a stratigraphic simulator, which is computer-run software for reconstructing the sedimentary processes that have affected the basin from an earlier geologic time to the current time. Thus, a numerical stratigraphic simulation is generally implemented in a discrete manner over time. That is a stratigraphic simulation simulates the stratigraphic state of the basin for a succession of time steps. A time step of a stratigraphic simulator corresponds to a geologic time period during which sedimentary deposits or erosions have modified the basin. The properties (including porosity and mineralogy) of these deposits can be relatively heterogeneous in the basin. Simulation of the filling history of a sedimentary basin is achieved from the input parameters representative of the sedimentary history of the basin under study. According to an implementation of the invention, the input parameters of a stratigraphic simulation can be at least (1) the space available for sedimentation, linked with at least one tectonic and eustatic movements, and with the mechanical compaction of the sediments (or squeezing together of sediments under the effect of the weight of overlying layers), (2) the sediments supplied to the basin, either through the boundaries or through in-situ production or precipitation, (3) the transport of these sediments (transport capacity assessed from the characteristics of the sediment, such as the size of the grains or the density thereof, from the water flux flowing at the ground surface and the local slope of the basin) in the available created space. The system of equations describing these processes can for example be solved by a finite-volume spatial discretization and an explicit finite-volume scheme. According to an implementation of the invention, the result of a stratigraphic simulation for a time step can correspond to a grid representation where each cell is at least filled with the following data: sediment content (sand, clay, carbonates, organic matter, etc.) and depositional environments (in particular the bathymetry at the time of deposition). Conventionally, the grid representation resulting from a stratigraphic simulation is also informed with characteristic properties of the depositional environment (water depth, basin elevation, etc.). A description of such a stratigraphic simulator can be found in document [9]. An example of such a stratigraphic simulator is the DIONISOS FLOW® software (IFP Energies nouvelles, France).

According to an implementation of the invention, the numerical simulation can be a basin simulation. Conventionally, a basin simulator allows reconstruction of at least one of geological and geochemical processes that have affected the basin, from a geologic time t to the current time. Conventionally, the period over which the history of this basin is reconstructed is discretized into geological events, also referred to as states. Thus, two states are separated by a geological event (corresponding for example to a particular sediment deposition, which can extend over a hundred years to a few million years). A basin simulator is based on a grid representation of the basin, also referred to as basin model. The basin simulator allows determination of such a model for each state. Thus, a basin simulator allows completion of physical properties relative to the basin under study in each cell of the grid representation associated with each state. Examples of the physical properties estimated by a basin simulator are generally temperature, pressure, porosity and density of the rock contained in the cell considered, saturation and TOC (total organic carbon). Conventionally, a basin simulator further allows calculation of the amount and the composition of thermogenic hydrocarbons, using a kinetic model fed with kinetic parameters. Thus, basin simulation solves a system of differential equations describing the evolution over time of the physical properties being studied. A finite-volume discretization method as described for example in document can be used for this purpose. For each state, it is necessary to solve the equations in small time increments (that is with a small-time step dt) until the next state. According to the principle of cell-centered finite-volume methods, the unknowns are discretized by a constant value per cell, and the (mass or heat) conservation equations are integrated in space on each cell and in time between two successive time steps. The discrete equations then express that the quantity conserved in a cell in a given time step is equal to the quantity contained in the cell in the prior time step, increased by the flux of quantities that have entered the cell and decreased by the flux of quantities that have left the cell through its faces, plus external supplies. An example of such a basin simulator is the TemisFlow™ software (IFP Energies nouvelles, France).

Also according to an implementation of the invention wherein the numerical simulation is a basin simulation, it is further possible to reconstruct beforehand the past architectures of the basin for various basin states. The grid representation constructed in the previous step, which represents the basin at the current time, is therefore deformed in order to represent the anti-chronological evolution of the subsoil architecture over geologic times, and for the various basin states. A grid representation is thus obtained at the end of this step for each state. According to a first embodiment, structural reconstruction can be particularly simple if it is based on the hypothesis that the deformation thereof results only from a combination of vertical movements through sediment compaction or through uplift or downwarp of the basement thereof. This technique, known as backstripping, is described for example in document [11]. According to another embodiment, in the case of basins whose tectonic history is complex, notably basins with faults, it is advisable to use techniques with less restrictive hypotheses, such as structural restoration. Structural restoration is for example described in document FR-2,930,350 A1 corresponding to US published patent application 2009/0265152 A1. Structural restoration calculates the successive deformations undergone by the basin, by integrating the deformations due to compaction and those resulting from tectonic forces.

Thus, at the end of this step, whatever the numerical simulation used, at least one grid representation of the (notably current) basin is obtained for each possible value combination of the uncertain parameters. Each cell of these grid representations contains at least one value of the physical property of interest or property values allowing determination of one value of the property of interest (for example by linear combination of several property values in the cell being considered).

4) Construction of an Approximate Analytical Model of a Spatial Distribution of the Physical Property

This step determines a realization of a spatial distribution of the physical property of interest for each grid representation of the grid representations, in applying a principal component analysis to the realizations of the spatial distribution of the physical property, and in selecting the components resulting from the principal component analysis for which the sum of the associated eigenvalues is above a predefined threshold. An approximate analytical model relative to the spatial distribution of the property is subsequently determined by constructing an approximate analytical model for each selected component.

According to an implementation of the invention, realization of a spatial distribution of the physical property of interest of a grid representation can correspond to the distribution of the values of the physical property of interest for at least one sub-set of cells of the grid, such as for example a column of cells in the grid, a group of cells of the grid corresponding to the same geological layer, or any other group of cells. It is clear that this step can also be applied to all the cells of the grid representation. The distribution of the values of the physical property of interest is considered for all the cells of the grid.

According to another implementation of the invention, the realization of a spatial distribution of the physical property of interest of a grid representation can be determined from the values of one or more physical properties of the grid representation, for example from a linear combination of one or more physical properties.

In the following, the spatial distribution of the physical property y for the combination of uncertain parameters θⱼ is denoted by y(u, θⱼ), with j ranging from 1 to n, and u is the position of the cell in the basin. In addition, the set of spatial distributions of the physical property of interest y for the design of experiments D is denoted by y(D)=(y(u, θⱼ))_{j=1 . . . n}. It is the training set. Moreover, the number of cells of the spatial distribution is denoted by N.

According to the invention, a principal component analysis (PCA) is applied to the realizations of the spatial distribution of the physical property of interest obtained for each uncertain parameter value combination. In general, a principal component analysis of a geostatistical variable represents this variable in a basis formed by the eigenvectors of its covariance operator. A functional representation of the random field is thus obtained. From such an analysis, it is possible to define a random field approximation that represents a quantifiable part of the process variance by keeping only a limited number of components in this representation.

With the notations defined above, the decomposition into principal components of spatial distributions y(D) can be written as follows:

y(u,θⱼ)=Σₖ₌₁^{M}αₖ(θⱼ)ϕₖ(u) (1)

where ϕₖ(u) are the basis vectors, equal to the eigenvectors of the covariance matrix, αₖ(θⱼ) are the projection coefficients on this basis, also referred to as components, and M is such that M=min (N, n). In this decomposition, it is clear that the basis vectors are orthogonal and sorted in descending order of the associated eigenvalues, corresponding to the descending order of variance explained by these basis vectors (variance of the components according to each vector).

Advantageously, it is possible to keep only the first m components of the basis corresponding to a given minimum percentage of the total variance of response y (generally at least 95%). This percentage is equal to the normalized sum of the corresponding eigenvalues. This generally allows reproduction in a satisfactory manner the spatial distributions of the physical property y(D) while capturing the essential part of the variance of this set. Equation (1) can then be modified as follows:

y(u,θⱼ)≈Σₖ₌₁^{m}αₖ(θⱼ)ϕₖ(u) (2)

According to the invention, an approximate analytical model of the spatial distribution of the physical property of interest is then constructed with the approximate analytical model being a function of the uncertain parameters. An approximate analytical model, also referred to as metamodel or response surface, is a model that approximates the relation between the simulation input parameters (in particular the uncertain parameters) and an output of this simulation, or any other variable calculated from the simulation outputs.

According to an implementation of the invention, the metamodel ŷ of the physical property of interest can be written, for any combination of parameters θ (and not only for the combinations of uncertain parameters predefined in step 2), as follows:

y(u,θ)=Σₖ₌₁^{m}\hat{α}ₖ(θ)ϕₖ(u) (3)

where \hat{α}ₖ(θ) represents the metamodel approximating component αₖ(θ), constructed from the values calculated for this component on training set y(D).

According to an implementation of the invention, a metamodel approximating a scalar variable of interest can be constructed by use of a polynomial regression, Gaussian processes or neural networks, or any similar method.

Thus, in this step, an approximate analytical model of the physical property of interest is constructed by constructing an approximate analytical model for each principal component selected according to a threshold relating to the variance as described above. In general, an approximate analytical model allows approximation of a large number of simulations at a lower cost, and therefore exploration of the uncertain parameters space.

5) Improvement of the Approximate Analytical Model of the Spatial Distribution of the Physical Property

This step is iterative. It can be repeated several times as long as at least one stopping criterion has not been satisfied. In this step, for a given iteration, improvement of the approximate analytical model of the spatial distribution of the physical property of interest is sought by applying an adaptive sequential planning method in order to determine at least one additional combination of the possible values of the uncertain parameters. “Improvement of the approximate analytical model” is understood to be improvement of the accuracy thereof. Once an additional combination determined, steps 3) and 4) described above are applied again to the new combinations of values of the uncertain parameters, formed by the combinations of values of the uncertain parameters in the previous iteration and at least an additional combination of values of the uncertain parameters determined in the current iteration.

In other words, in this step, it is assessed whether the approximate analytical model of the spatial distribution of the physical property of interest is satisfactory and, in the opposite case, additional data is automatically added to the training set in order to construct a more accurate approximate analytical model taking account of enriched data. An improved approximate analytical model allows prediction of the physical property of interest with greater accuracy.

In general, an adaptive sequential planning method enriches a given training set (and more specifically the set of combinations of values of the uncertain simulation parameters) by using both the definition of this set and the information provided by the metamodel constructed on this set.

Advantageously, if a Gaussian process regression method is used to construct an approximate analytical model of a given scalar property, an adaptive sequential planning method based on various criteria can be implemented, such as: maximum kriging variance (Maximum Mean Square Error MNISE, See document [5]), cross validation error-weighted maximum kriging variance (adjusted variance, See document [6]), kriging variance integration (Integrated Mean Squared Error IMSE, See document [7]), or hierarchical adaptive designs of experiments (See document [8]).

According to the invention, an adaptive sequential planning method is applied to the approximate analytical models of the components resulting from the principal component decomposition, starting with the components associated with the largest eigenvalues. More precisely, in the first iteration, component αₖ associated with the largest eigenvalue whose metamodel \hat{α}ₖ does not satisfy the target quality defined by a value of an accuracy indicator is identified. A sequential planning method is subsequently applied to metamodel \hat{α}ₖ until the target quality is reached, iteration after iteration. We then proceed to the next component in an additional iteration, and so on until a target quality is reached for all the metamodels of the components. The purpose here is to primarily improve the prediction on the components corresponding to the highest variances of the response.

According to the invention, at least one stopping criterion is assessed at each iteration.

According to an implementation of the invention, a stopping criterion relative to the accuracy of the approximate analytical model, that is an accuracy beyond which it is no longer considered useful to improve the approximate analytical model, can be predefined.

According to a variant of this implementation of the invention, it is possible to define an accuracy indicator relative to the approximate analytical models of the components resulting from the principal component analysis in the current iteration.

According to an implementation of the invention, an accuracy indicator denoted by Q2, relative to an approximate analytical model of a component, can be determined as follows:

$$Q 2 = 1 - \frac{{\sum }_{i = 1}^{n} {( α ( {θ}_{i} ) - {\hat{α}}_{- i} ( {θ}_{i} ) )}^{2}}{{\sum }_{i = 1}^{n} {( α ( {θ}_{i} ) - \overline{α} )}^{2}}$$

where \hat{α}₋ᵢ is the approximate analytical model obtained for a from the design of experiments D₋ᵢ=(θⱼ)_{1≤j≠i≤n}, and α̅ represents the average of values α(D). More precisely, this approach uses the cross validation technique known as leave-one-out (LOO-CV), wherein complementary metamodels obtained by ignoring one of the points of the training set are considered, and by calculating the error between the simulated value at this point and the value predicted by the metamodel. The prediction errors thus calculated are then grouped together in a global indicator. The value of accuracy indicator Q2 is all the closer to 1 as the error it quantifies is small.

According to another implementation of the invention, which may however be combined with the implementation described above, it is also possible to estimate an accuracy indicator of an approximate analytical model of a component from an additional design of experiments, denoted by Dₜₑₛₜ=(θ′ⱼ)_{1≤j≤ntest} for example, independent of the training set of the current iteration. An accuracy indicator denoted by R2 can then be defined as follows:

$$R 2 = 1 - \frac{{\sum }_{j = 1}^{ntest} {( α ( {θ}_{j}^{′} ) - \hat{α} ( {θ}_{j}^{′} ) )}^{2}}{{\sum }_{j = 1}^{ntest} {( α ( {θ}_{j}^{′} ) - \overline{α} )}^{2}}$$

where \hat{α} is the metamodel obtained for a from design of experiments D and α̅ represents the average of values α(Dₜₑₛₜ).

According to an implementation of the invention, a general stopping criterion can further be defined for the iterative process, which may correspond to a threshold relative to accuracy indicators Q2 and/or R2 associated with each or some of the components. Alternatively or cumulatively, a stopping criterion can also be defined as a threshold relative to the average, over all the cells of the spatial distribution, of indicators at least one of Q2, R2, their median, their maximum and even minimum value, etc. In a complementary manner, a stopping criterion based on monitoring of the evolution of such indicators during iterations can also be defined. For example, it may be concluded that addition of additional combinations is no longer effective if a stagnation of the accuracy indicators is observed with the iterations. Finally, a predefined stopping criterion can be that a maximum number of iterations in steps 3 to 5 of the method according to the invention, or a maximum number of simulations performed.

These criteria are to ensure the efficiency of the method according to the invention to automatically plan new simulations to be carried out and to avoid as far as possible unnecessary simulations.

6) Estimation of Uncertainties Associated with the Spatial Distribution of the Physical Property

This step determines uncertainties associated with the spatial distribution of the physical property, from the improved approximate analytical model obtained after applying the previous steps. Advantageously, uncertainties associated with the spatial distribution of the physical property are quantified by at least one of a sensitivity analysis and a risk analysis.

According to an implementation of the invention, a sensitivity analysis relative to the spatial distribution of the physical property of interest can be carried out from the improved approximate analytical model. In general, a sensitivity analysis allows analysis of the impact of the uncertainty of each parameter on the simulator responses. Such a technique is for example described in document [2].

According to an implementation of the invention, a variance-based global sensitivity analysis can be performed from the improved approximate analytical model, for example according to the Sobol' method as described in document [12]. A large sample of the uncertain parameters space is therefore generated, the corresponding realizations of the spatial distribution of the property of interest are estimated by use of the improved approximate analytical model, and the part of the variance of the property of interest due to the variability of each parameter alone (main effect) or in interaction with other parameters is quantified in each cell of this spatial distribution. The influence of each parameter in each cell of the spatial distribution of the property of interest is thus obtained.

Alternatively or cumulatively, a risk analysis relative to the spatial distribution of the physical property of interest can be performed from the improved approximate analytical model. A large sample of uncertain parameters (of Monte Carlo type) can for example be generated, and the corresponding realizations of the spatial distribution of the property of interest can be estimated by use of the improved approximate analytical model. This provides in each cell of the spatial distribution a large sample of the property of interest that can be analyzed. Percentiles can for example be calculated for this property, or the probability that the physical property in this cell is in a given target range can be estimated. A spatial distribution of the percentiles or of the probabilities of occurrence is thus obtained (see document [2] for example).

7) Exploitation of the Hydrocarbons in the Basin

This optional step is to be carried out, after the previous steps, in the case of the method according to the second aspect of the invention, which is a method of exploiting the hydrocarbons of a sedimentary basin.

After carrying out the previous steps, at least one accurate approximate analytical model of at least one physical property of interest in the sedimentary basin and an estimation of the uncertainties associated with at least this physical property of interest are available.

An accurate analytical model of at least one physical property of interest is advantageous for fast assessment of the petroleum potential of the basin. It can notably be used to assess the probability of occurrence of events in connection with the basin properties, characterized by the joint presence of several properties in target ranges. Notably, it can allow assessment of a probability of presence of the resources sought, such as a hydrocarbon accumulation. A reservoir presence probability map defined by the probability in each column of the basin that the deposited sediment thickness and the sand concentration are above a given threshold can be assessed for example. These probabilities can be included in the decision-making process relative to drilling new exploration wells, and will provide data to enrich the basin model. Thus, according to such analyses, a reservoir can be identified in the basin, and at least one scheme for exploiting the hydrocarbons contained in the sedimentary basin under study can be determined.

According to an implementation of the invention, from at least the uncertainties associated with the spatial distribution of the physical property, a reservoir potential can be identified in the basin and at least one scheme for exploiting the hydrocarbons contained in the sedimentary basin under study can be determined.

Generally, an exploitation scheme comprises a number, a geometry and a site (position and spacing) for injection and production wells to be drilled in the basin. An exploitation scheme can further comprise a type of enhanced recovery for the hydrocarbons contained in the reservoir(s) of the basin, such as enhanced recovery through injection of a solution containing one or more polymers, CO2 foam, etc. A hydrocarbon reservoir exploitation scheme must for example enable a high rate of recovery of the hydrocarbons trapped in this reservoir, over a long exploitation time, and require a limited number of wells. In other words, the specialist predefines evaluation criteria according to which a scheme for exploiting the hydrocarbons contained in a sedimentary basin is considered sufficiently efficient to be implemented.

According to an embodiment of the invention, exploitation schemes can be defined for the hydrocarbons contained in one or more geological reservoirs of the basin under study, and at least one evaluation criterion is assessed for these exploitation schemes, by use of a reservoir simulator (such as the PUMA FLOW® software (IFP Energies nouvelles, France)). These evaluation criteria can comprise the amount of hydrocarbons produced for each of the various exploitation schemes, the curve representative of the production evolution over time for each well being considered, the gas-oil ratio (GOR) for each well being considered, etc. The scheme according to which the hydrocarbons contained in the reservoir(s) of the basin under study are really exploited can then correspond to the one meeting at least one of the evaluation criteria of the various exploitation schemes. It is noted that the definition of exploitation schemes to be tested can itself be determined in an automated manner, for example by the COUGAR FLOW® software (IFP Energies nouvelles, France).

Then, once an exploitation scheme is determined, the hydrocarbons trapped in the petroleum reservoir(s) of the sedimentary basin under study are exploited according to this exploitation scheme, notably at least by drilling the injection and production wells of the determined exploitation scheme, and by installing the production infrastructures necessary to the development of this or these reservoirs. In cases where the exploitation scheme has also been determined by estimating the production of a reservoir associated with different enhanced recovery types, the selected additive type(s) (polymers, surfactants, CO₂ foam) are injected into the injection well.

It is understood that a scheme for exploiting hydrocarbons in a basin can evolve during the exploitation of the hydrocarbons of this basin, for example according to additional basin-related knowledge acquired during this exploitation, and to improvements in the various technical fields involved in the exploitation of a hydrocarbon reservoir (advancements in the field of drilling, enhanced oil recovery for example).

Alternatively to hydrocarbon recovery, the steps of the method can also be carried out within the context of methods involving geothermal energy, underground energy storage or underground gas storage.

For these applications, after carrying out the previous steps, at least an accurate approximate analytical model of at least one physical property of interest in the sedimentary basin and an estimation of the uncertainties associated with at least this physical property of interest are available.

An accurate analytical model of at least one physical property of interest is advantageous for fast assessment of the geothermal potential, or of the underground gas or energy (compressed gas for example) storage potential.

Equipment and Computer Program Product

The method according to the invention is implemented by an equipment (a computer workstation for example) comprising data processing means (a processor) and data storage means (a memory, in particular a hard drive), as well as an input/output interface for data input and method results output.

The data processing means are configured for carrying out in particular steps 2 to 6 described above.

Furthermore, the invention concerns at least one of a computer program product downloadable from a communication network, recorded on a computer-readable medium and processor executable non-transient program code instructions for implementing the method as described above, when the program is executed on a computer.

### Examples

The features and advantages of the method according to the invention will be clear from reading the application example hereafter.

For this application example, a sedimentary basin is considered in a passive margin context. This margin is characterized by a sediment supply of sand and clay at a point located to the west of the margin at the time of its formation. The numerical simulation according to the invention is a stratigraphic simulation, and the physical property of interest is the total thickness of the sediments deposited in each column of the stratigraphic model.

The 9 uncertain parameters considered are related to the various processes involved in the formation of the sedimentary basin: accommodation, sediment supply and transport. They are associated with a law of uniform distribution in a given range.

The method according to the invention is then applied to the total thickness of sediments deposited in each column of the grid representation. The physical property of interest thus is the total thickness of sediments deposited in each column of the grid. More precisely, for this example, the spatial distribution of interest is a map of size 1000 km×1000 km in a horizontal plane, discretized in a grid pattern of 100×100 cells. An initial design is considered of experiments of LHS type of 20 combinations of the possible values of the uncertain simulation parameters which is added at each iteration one (case 1) or five (case 2) new combinations of the possible values of the uncertain simulation parameters. The metamodels approximating the components are constructed by Gaussian processes, and addition of the combinations are done according to the maximum kriging variance method. The principal component analysis leads to select 4 components (denoted by Comp1, Comp2, Comp3, Comp4) corresponding to 95% of the variance.

The stopping criteria considered are:
value of accuracy indicator Q2 (as defined in section 5) greater than 0.95 for the metamodels of the components,
value of median coefficient R2 (as defined in section 5) in the zone of interest for the total sediment thickness greater than 0.95,
two stagnation criteria as the iterations progress for median coefficient R2 in the zone of interest for the total sediment thickness.

A maximum number of simulations is also set to 98.

The implementation of the method according to the invention is repeated for 5 different initial designs of experiments Exp1, Exp2, Exp3, Exp4, Exp5. The prediction quality is assessed by use of an independent set of 50 points.

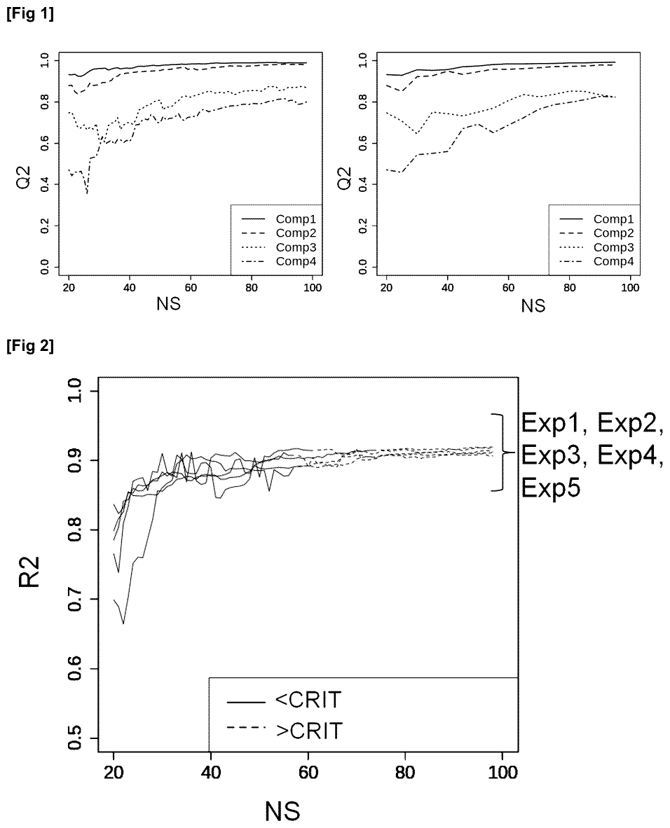

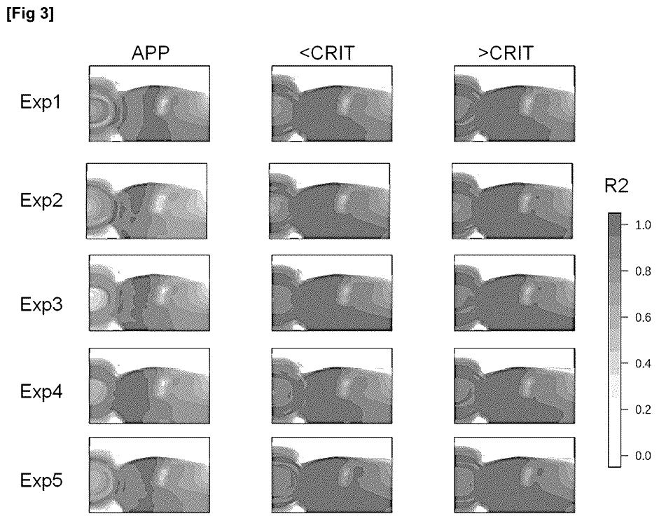

FIG. 1 illustrates the evolution of accuracy indicator Q2 for the 4 components Comp1, Comp2, Comp3, Comp4 as a function of the number of simulations NS, in case 1 (left-hand figure) and in case 2 (right-hand figure), and for the first design of experiments Exp1. FIG. 2 illustrates the evolution of median accuracy indicator R2 on the spatial distribution of the total sediment thickness for the 5 different designs of experiments Exp1, Exp2, Exp3, Exp4 and Exp5, with the addition of 1 combination per iteration (case 1), at least one of the stopping criteria relating to this indicator being satisfied after about 58 simulations (see the delimitation between the curve portions “<CRIT” and “>CRIT”). FIG. 3 illustrates the distribution of the values of accuracy indicator R2 for the total sediment thickness in each cell (100×100 cells in total) of the spatial distribution being considered for the 5 designs of experiments Exp1, Exp2, Exp3, Exp4, Exp5 with addition of 1 point per iteration (case 1), for the training set (column “APP”, left), until at least one of the predefined stopping criteria is satisfied (column “<CRIT”, middle), and by continuing the iterations until 98 simulations are reached (column “>CRIT”, right).

It can be seen in FIG. 1, the method of adding iterative points according to the invention globally allows to improve the prediction quality of the approximate analytical models for the various components. Furthermore, it can be observed that adding 5 points simultaneously during an iteration does not degrade the results. Besides, it can be seen in FIG. 2 that this improvement is also accompanied by an overall increase in median indicator R2. Finally, it can be observed in FIG. 3 that the stopping criteria relative to the accuracy indicators (criteria 2 and 3 above) are satisfied. Indeed, the value of coefficient R2 in the cells is globally satisfactory once one of these criteria is reached, and it increases only slightly if the iterations are continued.

1-7. (canceled)

8. A method for determining uncertainties relative to at least one physical property of a sedimentary basin using a numerical simulation which is a computer-implemented stratigraphic simulation or basin simulation, carried out with simulation parameters comprising steps of:
A) measuring with sensors physical quantities relative to the basin and determining at least values of the simulation parameters;
B) selecting uncertain simulation parameters and defining combinations of possible values of the uncertain simulation parameters;
C) determining grid representations of the basin using cells by using the numerical simulation, each of the grid representations being obtained for one of the combinations of possible values of the uncertain parameters, each of the cells of the grid representations comprising at least one value allowing the at least one physical property to be determined,
wherein, for at least one of the physical properties of the sedimentary basin, performing at least steps of:
D) for each of the grid representations determining a realization of a spatial distribution of the at least one physical property, applying a principal component analysis to the realization of the spatial distribution of the at least one physical property, selecting principal components having a sum of associated eigenvalues greater than a predefined threshold, and determining an analytical model of the spatial distribution of the at least one physical property by constructing an analytical model for each of the selected principal components;
E) constructing, as long as a stopping criterion is not satisfied, an analytical model of the spatial distribution of the at least one physical property iteratively with improved accuracy by determining for each iteration, at least one additional combination of possible values of the uncertain parameters by using an adaptive sequential planning method applied to the analytical models of the selected principal components, by considering the selected principal components in a descending order of their eigenvalues until an accuracy indicator relative to at least the selected principal component of a current iteration is reached, and by repeating steps C) to E); and
F) from the analytical model with improved accuracy of the spatial distribution of the at least one physical property, uncertainties relative to the spatial distribution of the at least one physical property of the sedimentary basin model are determined.

9. A method as claimed in claim 8, wherein the at least one stopping criterion depends on at least one accuracy indicator of the analytical model for each of the selected principal components.

10. A method as claimed in claim 8, wherein the analytical model for each of the selected principal components is determined by using a Gaussian process regression.

11. A method as claimed in claim 9, wherein the analytical model is determined by using a Gaussian process regression.

12. A method as claimed in claim 8, wherein the adaptive sequential planning method is selected from a method of estimating a maximum kriging variance, a method of a cross validation error-weighting by estimating a maximum kriging variance, a method of kriging variance integration, and an hierarchical design of experiments.

13. A method as claimed in claim 9, wherein the adaptive sequential planning method is selected from a method of estimating a maximum kriging variance, a method of a cross validation error-weighting by estimating a maximum kriging variance, a method of kriging variance integration, and an hierarchical design of experiments.

14. A method as claimed in claim 10, wherein the adaptive sequential planning method is selected from a method of estimating a maximum kriging variance, a method of a cross validation error-weighting by estimating a maximum kriging variance, a method of kriging variance integration, and an hierarchical design of experiments.

15. A method as claimed in claim 11, wherein the adaptive sequential planning method is selected from a method of estimating a maximum kriging variance, a method of a cross validation error-weighting by estimating a maximum kriging variance, a method of kriging variance integration, and an hierarchical design of experiments.

16. A method as claimed in claim 8 wherein steps C) to F) are applied to each of the physical properties of the basin.

17. A method as claimed in claim 9 wherein steps C) to F) are applied to each of the physical properties of the basin.

18. A method as claimed in claim 10 wherein steps C) to F) are applied to each of the physical properties of the basin.

19. A method as claimed in claim 11 wherein steps C) to F) are applied to each of the physical properties of the basin.

20. A method as claimed in claim 12 wherein steps C) to F) are applied to each of the physical properties of the basin.

21. A method as claimed in claim 13 wherein steps C) to F) are applied to each of the physical properties of the basin.

22. A method as claimed in claim 14 wherein steps C) to F) are applied to each of the physical properties of the basin.

23. A method as claimed in claim 15 wherein steps C) to F) are applied to each of the physical properties of the basin.

24. A computer program product downloadable from at least one of a communication network, a recording on a tangible computer-readable medium which stores non-transient program code instructions for implementing the method of claim 8 when the non-transient instructions are executed by a processor.

25. A method for exploiting hydrocarbons in a sedimentary basin comprising determining uncertainties relative to at least one physical property of a sedimentary basin as claimed in claim 8, wherein, from at least one analytical model of improved accuracy of the spatial distribution of the at least one physical property and uncertainties relative to at least the physical property determining for the basin, a development scheme is constructed comprising selecting at least one site for at least one of an injection well and at least one of a production well and exploiting hydrocarbons in the basin by drilling the wells on the site and providing the at least production wells with exploitation infrastructures.
